(19) United States
(12) Patent Application Publication
(10) Pub. No.: US 2025/0371335 A1
(43) Pub. Date: Dec. 4, 2025

(54) MULTI-LEVEL MIXER MASKED AUTOENCODER

(71) Applicant: INTERNATIONAL BUSINESS MACHINES CORPORATION, ARMONK, NY (US)

(72) Inventors: Vijay Ekambaram, Chennai (IN); Arindam Jati, Bengaluru (IN); Nam H. Nguyen, Pleasantville, NY (US); Chandrasekhara K. Reddy, Kinnelon, NJ (US); Jayant R. Kalagnanam, Briarcliff Manor, NY (US)

(21) Appl. No.: 18/731,469

(22) Filed: Jun. 3, 2024

(51) Int. Cl. G06N 3/08; G06N 3/0455

(52) U.S. Cl. CPC G06N 3/08; G06N 3/0455

(57) ABSTRACT

An approach for training a multi-level mixer masked autoencoder with channel mixing across group dimensions model. The approach may involve expanding an input encoding from a time-series independent encoder and correlation encoding the expanded encodings. The approach may include compressing the correlation encodings. The approach may also include decoding the correlation encodings, based on a decoder head. Additionally, the approach may include determining the error of the decoded correlation encodings compared to the plurality of input features and updating one or more weights of the decoder head based on the error.

### STATEMENT REGARDING PRIOR DISCLOSURES BY THE INVENTOR OR A JOINT INVENTOR

The following disclosure(s) are submitted under 35 U.S.C. 102 (b) (1) (A):

The following invention was released to the public as a Time-Series Foundation Model library software developer kit as of Sep. 1, 2023.

### BACKGROUND

The present invention relates to machine learning models, and more specifically, to time-series phase mixer masked autoencoder models.

### SUMMARY

Embodiments of the invention disclosed herein may comprise an approach for training a multi-level mixer masked autoencoder with channel mixing across group dimensions model. Embodiments, may be a computer-implemented method, a computer system, and/or a computer program product. An embodiment may include expanding an input encoding from a time-series independent encoder. Further, embodiments may include correlation encoding the expanded encodings, based at least in part on mixing the encodings through a least one of the following, channel mixing, spatial mixing, and channel mixing. Further yet, embodiments may include compressing the correlation encodings. Embodiments, may also include decoding the correlation encodings, based on a decoder head. Additionally, embodiments may include determining the error of the decoded correlation encodings compared to the plurality of input features. Further, embodiments, may include updating one or more weights of the decoder head based on the error.

### BRIEF DESCRIPTION OF THE DRAWINGS

FIG. 1, depicts a block diagram of an exemplary computing environment capable of executing the inventive approach described herein, in accordance with an embodiment of the invention.

FIG. 2, depicts a block diagram of a phased mixer masked autoencoder multivariate time-series prediction system, in accordance with an embodiment of the invention.

FIG. 3 depicts a block diagram of a multi-level mixer masked autoencoder multivariate time-series prediction model architecture, in accordance with an embodiment of the invention.

FIG. 4 depicts a diagram showing the multi-level mixer masked autoencoder multivariate time-series prediction module architecture with channel mixing across group dimension, according to an embodiment of the invention.

FIG. 5 depicts a flowchart describing the steps of training a phased mixer masked autoencoder multivariate time-series prediction model, in accordance with an embodiment of the invention.

FIG. 6 depicts a flowchart describing the steps of training of a multi-level mixer masked auto encoder model in accordance with an embodiment of the present invention.

### DETAILED DESCRIPTION

Smart sensor are a critical component in the current industrial and commercial environment. These sensors can allow form improved functionality in processes including self-monitoring and predictive maintenance. In some industrial and commercial processes multivariate time-series can be effectively utilized to analyze the state of an industrial system. Multi-variate time-series data possesses the data of multiple sensors monitoring different aspects of a process. One important use case of multivariate time-series data is predicting the need for preventative maintenance. This preventative maintenance can reduce potentially costly damage and reduce the overall down time of systems involved in an industrial or commercial process. It would be advantageous to have a robust time-series representation learning model or process to bootstrap the modelling process. This bootstrap process can be similar in a sense to bootstrapping or finetuning a pretrained natural language processing model, pretrained in a general domain, to a specific domain. In other words, a time-series foundational model (“TSFM”) with predictive capabilities would be an advantageous thing to have.

Currently there are numerous challenges with TSFMs. There is a lack of unlabeled data to pretrain a foundational model. This is in contrast to natural language processing and vision model where unlabeled data is virtually unlimited, time-series data is almost always label due to the nature of time-series data collection (i.e., the sensors are always known and the units of measurement are always known). A potential solution to this lack of unlabeled data is simulated data or utilizing data from an unrelated domain to pre-train the TSFM.

Another challenge associated with TSFM is the quality of time-series data. In many cases, the data possesses noise which causes many challenges in the pretraining process. Further, when data is missing from a time-series, the gaps can cause overfitting due to the lack of data for that specific time or for that specific sensor (e.g., a sensor failed and was not repaired, causing large gaps in the data, while other sensors operated normally). In a TSFM it would be expected that the model would learn a representation that is tolerant to noise. It would also be expected that the learned representation would not over or underfit due to missing training data.

Multivariate time-series data is critical in current industrial and commercial processes. Multivariate data leverages spatial information across variables and temporal information within each series which can substantially improve downstream task predictions and the associated reactions to the data. Multi-variate time-series data is difficult to incorporate into a TSFM, due to the differences in the data and the inability of current time-series models to adequately learn the representations of the multi-variate time-series data. Potential solutions to this difficulty could include a new design of transformer in the TSFM to capture the spatial-temporal signal.

Another challenge associated with TSFM is distribution shift. Non-stationary data can alter the representation of a TSFM, this can cause a distribution shift between the data utilized in pretraining and the data used for downstream tasks. The potential solution to prevent a distribution shift is to utilize a large amount of data to pretrain the model, locking the representation distribution in place.

Currently TSFM include a patch time-series transformer model and a time-series mixer model. The PatchTST and the TSMixer use a transformer backbone and a simple linear head. The linear head forces the backbone to learn all of the detailed information required for reconstruction. This can impact the abstraction of the representation and negatively affect the performance of the down-stream tasks of the model.

A PatchTST is a channel-independent patch time series transformer. The PatchTST model is for time-series forecasting and self-supervised representation learning. The model utilizes two key components in its operation. First, a segmentation module segments time-series data into multiple subseries-level patches. These subseries-level patches are provided to the transformer as tokens. Second, each channel is independent of another channel. This allows each cannel to contain a single univariate time series which shares the same embeddings and transformer weights across the entire series.

A TSMixer is a lightweight neural architecture composed of multi-layer perceptron (MLP) modules. TSMixer is designed for multivariate forecasting and representation learning on patched time series. The TSMixer provides an efficient alternative to Transformers. The TSMizer is compised of a

Masked autoencoders are scalable vision learners. In a masked autoencoder, sections or pixels of an image are randomly masked (i.e., blacked out). The non-masked sections of the image are then fed to the encoder. A representation is generated based on the non-masked sections. The encoding is then fed to a decoder, the sections of the encoding are sequentially spaced out and null representations are added which represent the masked portions. The decoder is a linear head which is a smaller or thin version of the encoder head, enabling improved abstractions of the embeddings.

There are challenges in porting masked autoencoder techniques to a TSMixer. A TSMixer is that it is sequence invariant, meaning the TSMixer can only operate over a specific sequence length. This is unlike a transformer, which can operate over a variable sequence length. Therefore, if the encoder is trained only with n non-masked patches during pretraining, transformer based models allow for finetuning with n′ patches. However, the TSMixer requires n and n′ to be the same.

A simple approach to utilizing a model with an encoder such as a TSMixer or TSTpatch can include, a masking component to hide portions of the representations from a decoder, a thin decoder, and a pretrained linear head. In training and finetuning, the masked positions will vary for each sample in the training set. This requires the encoder patch representations to capture high level inter-patch information for effective reconstruction by the decoder. In other words, the input data is not masked, rather, the masking occurs at the hidden feature space (i.e., the encoding).

This approach provides at least two challenges, in versions with high hidden feature size, the model simply copies the data via the hidden features. This leads to poor generalization to downstream tasks. In versions with low hidden feature dimensionality, the model capacity drops significantly. This capacity drop leads to underfitting a poor overall performance. Potential solutions to these challenges are a model with a Phased mixer masked auto encoder architecture.

Further challenges include: during pretraining differing levels can occur. For example, pretraining with general data or pretraining with domain specific data. Also within a time-series, there is a notion of grouped multi-variate time-series, where the groups refer to a collection of multi-variate time-sereis which have cross correlations among them, for example, spatial groups, asset groups, product groups, pressure groups, etc.,

A multilevel Mixer MAE (trained with multi-backbone support can address these challenges. For example, a TimeSeries (“TS”) independent backbone can be pretrained in all available time series data, in a channel independent manner. The pretrained backbone is able to capture the generic physical processes of a univariate time-series when pre-trained with a large time series data corpus. This ensures a large learned general representation for all features. A TS correlation backbone can be added to the multi-level mixer MAE and pretrain it. During pretraining, there is an option to freeze the TS independent backbone or fine tune it depending on the requirements. The TS correlation backbone is designed to capture the cross-correlations of all the channels associated with the time-series data. A thin decoder head may be added as a head (e.g., a small mixer or transformer decoder and a linear prediction head) and the head is finetuned on top of the TS independent backbone and the TS correlation backbone based on the down-stream tasks. For example, the linear prediction head can forecast specific channel data associated with the time-series dataset.

Embodiments of the invention may be utilized in numerous domains where sequence-to-sequence or time-series data is available. For example, in energy systems such as natural gas production, where the output gas properties are dependent on side-streams. A task for such an example may be to model the output temperatures and pressures provided side-stream inlets. Embodiments of the present invention may overcome challenges with such a system including spatial correlation across different sensor data, different lagging times which influence the output, and fine and course resolution of such data.

In another embodiment, the presently disclosed invention may be utilized in food production such as milk powder production. The input data may include input liquid variables (e.g., viscosity, density, surface tension, mass rate, undissolved gas %, pressure, and temperature). Further downstream the variables to dry the powder may include temperature, humidity, and nozzle size of the spray tower. The prediction may be associated with the output capacity rate given the upstream variables.

In another embodiment, the presently disclosed invention may be utilized to predict chemical impurity levels given upstream variable (e.g., identifying key variables which affect impurity levels measured at a primary column outlet). Variables may include pressure and temperature readings from secondary and tertiary distillation columns, as well as initial input material impurity levels, reflux-to-feed ratios, and reactor input.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as phased mixer masked autoencoder multivariate time-series prediction code 200. In addition to phased mixer masked autoencoder multivariate time-series prediction code 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and phased mixer masked autoencoder multivariate time-series prediction code 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

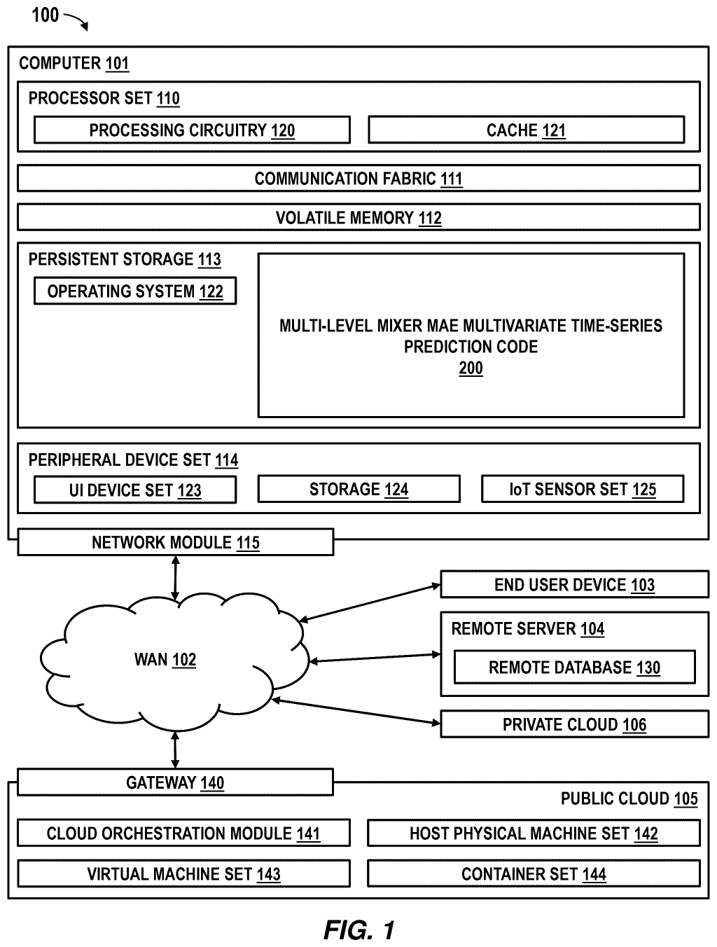

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in phased mixer masked autoencoder multivariate time-series prediction code 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in phased mixer masked autoencoder multivariate time-series prediction code 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Computing environment 100 and/or the components of computer environment 100 can be employed to use hardware and/or software to solve problems that are highly technical in nature (e.g., related to machine learning, multi-level mixer masked autoencoder training, etc.), that are not abstract and that cannot be performed as a set of mental acts by a human. Further, some of the processes performed may be performed by specialized computers to carry out defined tasks related to the phased mixer masked autoencoding of time series for machine learning model training. Computing environment 100 and/or components of Computing environment 100 can be employed to solve new problems that arise through advancements in technologies mentioned above and/or the like. Computing environment 100 can provide technical improvements to machine learning systems by increasing reducing computer storage requirements for training sets and providing improved and more efficient. For example, embodiments disclosed herein can be beneficial for multi-level masked autoencoder training.

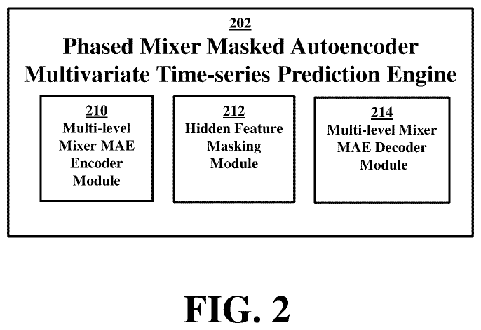

Now with reference to FIG. 2. FIG. 2 is a block diagram, depicting a phased mixer masked auto encoder multivariate time-series prediction engine (“prediction engine”) 202. Prediction engine 202 is a program or application which can run from phased mixer masked autoencoder multivariate time-series prediction code 200 as shown in FIG. 1. Prediction engine 202 can also determine the error between the encodings from the associated encoders and decoders. In an embodiment, prediction engine 202 can update or adjust the weights of the associated encoders and decoders, based on the determined error. Shown operational on prediction engine 202 is phased mixer masked autoencoder encoder module 210, hidden feature masking module 212 and phased mixer masked autoencoder decoder module 214. Prediction engine 202 can take multivariate time-series data input and predict future state variables based on the input data.

Phased Mixer MAE encoder module 210 is a computer module that can receive time series data as input or receive previously encoded time series data as input (e.g., tokenized data or data previously encoded). Phased mixer MAE encoder module 210 can be comprised of a time-series mixer backbone pretrained with multivariate data. In an embodiment, phased mixer MAE encoder module 210 can receive the input features of the time series data set and expand the features dimensionality into n phases. The expansion of the features allows for higher capacity of the model and prevents underfitting.

In an embodiment, Phased mixer MAE module 210 can encode the expanded features. For example, the encoding can mix the features via patches. In one example the features can be mixed via inter patch mixing and/or intra patch mixing. Phased mixer MAE module 210 can be a time series independent model. This allows for consistency among the encoding with respect to the variables associated with the multivariate time series data.

In an embodiment, phased mixer MAE module 210 can fold back or compress the encoded data. For example, the encoded data can be in the form of n phases. The encoded data can be compressed back to the original or initial phase size. Compressing the data back to the original size allows for better generalization of the latent data by the model for downstream tasks.

Hidden feature masking module 212 is a computer module that can receive encodings from phased mixer MAE encoding module 210. During training the compressed encodings can be received form phased mixer MAE encoding module 210. The encodings are comprised of numerous vectors sequentially ordered. Hidden feature masking module 212 can mask the vectors associated with the encodings. For example, the hidden feature masking module 212 can randomly select vectors and set the vectors to a null value. Hidden feature masking module 212 can then send the masked encodings to Phased mixer MAE decoding module 214 with the encodings and masked still in sequential order to preserve the temporal features of the time series dataset.

Phased mixer MAE decoder module 214 is a computer module that can receive encodings from phased mixer encoding module 210 during normal operations or masked encodings from hidden feature masking module 212 during training or fine-tuning. In an embodiment, phased mixer MAE decoder 214 can perform operations similar to those in phased mixer MAE decoder 210. For example, the received encoding values can be expanded in phase to n phases. The expanded phases can be encoded into a format usable by a linear prediction head. For example, a time series correlation encoder can encode the expanded encoding values. The time series correlation encoder takes into account all of the variables and channels associated with the time series data. This encoder incorporates all of the relationships and dependencies of the channels via channel mixing during the encoding process. For example, the expanded data can be mixed via inter patch mixing, intra patch mixing, and/or channel mixing. In an embodiment, during pretraining channel mixing in disabled, but during finetuning, channel mixing can be enabled.

In an embodiment, phase mixer MAE decoder 214 can compress or foldback the correlation encoded data into the initial or original received encoding size. The encoding size can be associated with an associated linear prediction head for phase mixer MAE decoder 214. In an embodiment, the compressed correlation encoding data can be fed into a linear prediction head. The linear prediction head can be a fully connected neural network that has been configured to receive correlation data and provide state variables as output. These outputs are the predictions based on the time-series data input. The state variables can have a variable value and a corresponding temporal value.

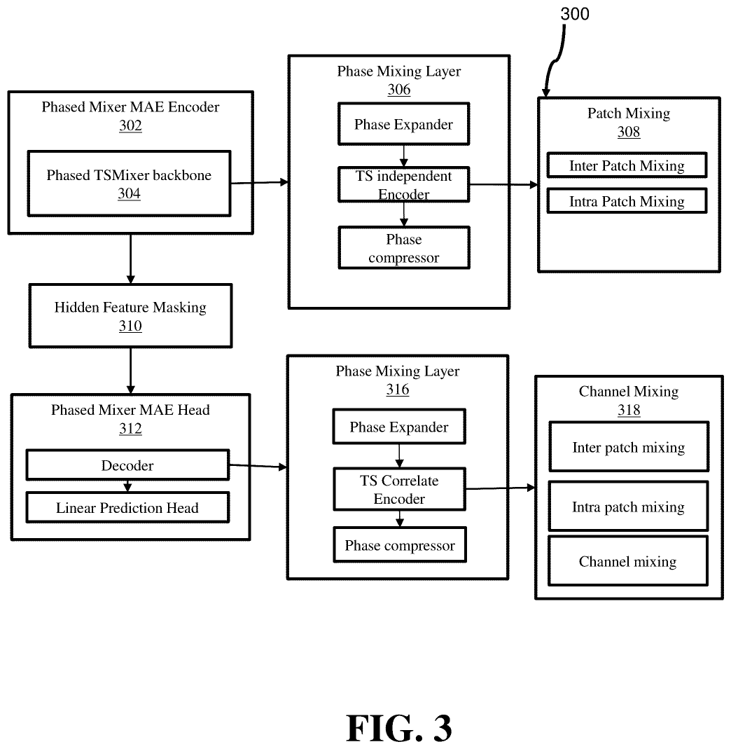

Now with reference to FIG. 3. FIG. 3 is a block diagram of a phased mixer masked autoencoder multivariate time-series prediction module architecture (“phased architecture”) 300, according to an embodiment of the invention. While only three components are show in FIG. 3, multiple components can be within an architecture and maintain the spirit and inventive concept of the disclosure. The first component of architecture 300 is phased mixer MAE encoder 302 is shown with a phase TSMixer backbone 304. The phase TSMixer backbone 304 can be a model trained with historical data set for general use. Phase mixing layer 306 is an expanded block of a step that occurs in TSMixer backbone 304. Phase mixing layer 306 comprises a phase expander, a time series independent encoder and a phase compressor. In Phase mixing layer input the phases of the input features are expanded by n phases to increase the model's capacity and fed into TS independent encoder. The TS independent encoder utilizes patch mixing during the encoding process to preserve the relationships and dependencies of the variate or channel during encoding as shown in patch mixing 308. The encodings are fed to Phase compressor in Phase mixing layer 306. Phase compressor reduces the phase from n phases to the initial phase size. This compression leads to an improved representation learning in training and fine tuning.

The second component of phased architecture 300 is hidden feature masking 310. Hidden feature masking 310 takes the compressed encodings and masks portions of the encodings. In an embodiment, hidden feature masking 310 masks random embeddings and keeps the sequential order of the embedding. This hidden feature masking replaces raw data with blank or null values. This masking allows for the phasing components to highly compress the hidden feature size of the encodings without compromising the model capacity.

The third component is phased mixer MAE head 312. Shown operational on phased mixer MAE head is decoder and linear prediction head. The decoder takes the masked embeddings in the training and finetuning stages and performs at a minimum the operations shown in phase mixing layer 316. Phase mixing layer 316 performs a phase expansion, a time series correlation encoding, and a phase compression of the correlation encodings. During the TS correlation encoding, the phase expanded inputs are mixed as in channel mixing 318. Channel Mixing 318 performs one or more of the following operations while performing the correlation encoding, inter patch mixing, intra patch mixing and/or channel mixing. The mixing allows for correlations between various temporal sequences among the multivariate channels of the time series data.

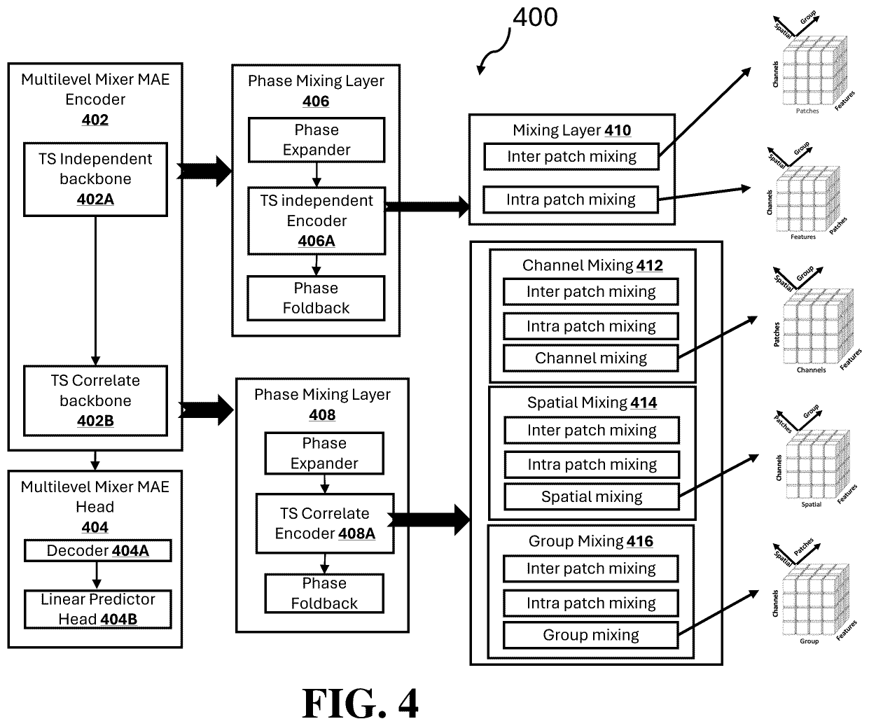

Now with reference to FIG. 4, FIG. 4 is a block diagram of a multi-level mixer masked autoencoder multivariate time-series prediction module architecture (“multi-level architecture”) 400, according to an embodiment of the invention. The first component of multi-level architecture 400 is multi-level mixer MAE encoder 402. Shown operational on multi-level mixer MAE encoder 402 is a modular backbone consisting of two models, a TS independent backbone and a TS correlate backbone. Phase mixing layer 406 is a process carried out by TS independent backbone 402A. Phase mixing layer 406 consists of a phase expansion of input features, a TS independent encoder 406A, and a phase foldback of the encodings from TS encoder 406A. Mixing layer 410 is a process carried out within phase mixing layer 406. Phase mixing layer 406 consists of interpatch mixing and intrapatch mixing.

Multi-level Mixer MAE encoder 402 also has TS correlate backbone. TS correlate backbone 402B has as a process phase mixing layer 408. Phase mixing layer 408 comprises a phase expander, a TS correlate encoder, and a phase foldback. The TS correlate encoder 408A has three separate mixing processes that occur during the encoding process during training and fine tuning. These mixing processes allow for improved learning representations of the correlations between variables in the time series data sets. The three mixing operations are channel mixing 412, spatial mixing 414, and group mixing 416.

The second component of multi-level architecture 400 is multi-level mixer MAE head 404. Shown operational on multi-level mixer MAE head is decoder 404A and linear predictor head 404B. Decoder 404A is a thin layer that can receives state variable from time-series data sets and input the encoding into linear predictor head 404B. This is possible because it has been trained with the learning representations of the TS independent backbone 402A and the TS correlate backbone 402B. This learning representation contains the latent single channel and the latent correlation data of the entire system (e.g., channels, spatial data, and group data) associated with the time series data. Linear predictor head 404B can forecast the state variable of a corresponding system based on the encodings from decoder 404A. Linear predictor head 404B can be a fully connected multi-layer perceptron or a neural network model of similar capabilities.

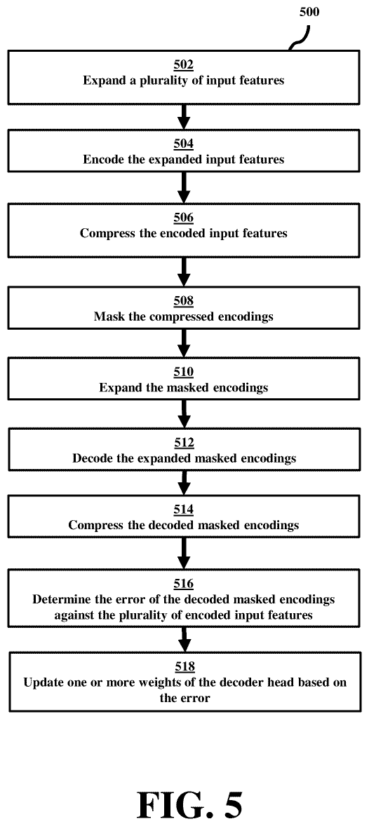

Now with reference to FIG. 5, FIG. 5 depicts flowchart 500 for training a phase mixer masked autoencoder model, in accordance with an embodiment of the present invention. At step 502, phased mixer MAE encoder module 210, expands a plurality of input features. At step 504 phased mixer MAE encoder module 210 encodes the expanded input features. At step 506, phased mixer MAE encoder module 210 compresses the encoded input features. At step 508, hidden feature masking module 212 masks the compressed encodings. At step 510, phased mixer MAE decoder module 214 expands the masked encodings. At step 512, phased mixer MAE decoder module 214 decodes the expanded masked encodings. At step 514, phased mixer MAE decoder module 214 compresses the masked encodings. At step 516, prediction engine 202 determines the error of the decoded masked encodings against the plurality of encoded input features. At step 518, prediction engine 202 updates one or more weights of the phased mixer MAE encoder module 210 and/or phased mixer MAE decoder module 214, based on the determined error.

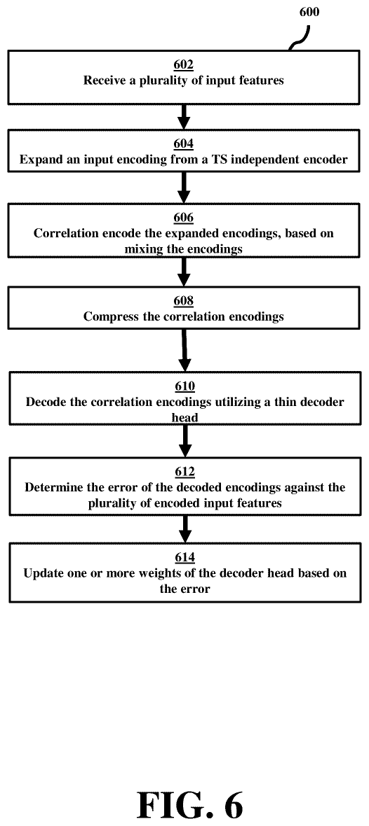

Now with reference to FIG. 6, FIG. 6 is flowchart 600 depicting training of a multi-level mixer masked auto encoder model in accordance with an embodiment of the present invention. At step 602, prediction engine 202 receives a plurality of input features associated with a time-series data set. At step 604, phased mixer MAE encoder module 210, expands a plurality of input features. At step 606, phased mixer MAE encoder module 210 performs a correlation encoding on the expanded input features. At step 608, phased mixer MAE encoder module 210 compresses the correlation encoded input features. At step 610, phased mixer MAE decoder module 214 decodes the correlation encodings. At step 612, prediction engine 202 determines the error of the decoded encodings against the plurality of encoded input features. At step 614, prediction engine 202 updates one or more weights of the encoder and or decoder heads based on the error.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for training a multi-level mixer masked autoencoder with channel mixing across group dimensions model, the computer-implemented method comprising:
receiving, by the processor, a plurality of input features;
expanding, by a processor, an input encoding from a time-series independent encoder;
correlation encoding, by the processor, the expanded encodings, based at least in part on mixing the encodings through a least one of the following, channel mixing, spatial mixing, and channel mixing.
compressing, by the processor, the correlation encodings;
decoding, by the processor, the correlation encodings, based on a decoder head;
determining, by the processor, the error of the decoded correlation encodings compared to the plurality of input features; and
and updating, by the processor, one or more weights of the decoder head based on the error.

2. The computer-implemented method of claim 1, wherein the decoder head is comprised of a thin decoder with mixer architecture and a linear prediction head.

3. The computer-implemented method of claim 1, wherein encoding the expanded input features further comprises:
expanding the time-series independent encoding, the, based at least in part on mixing the masked encodings through at least one of the following: intra patch mixing and interpatch mixing.

4. The computer-implemented method of claim 1, further comprising:
inputting, by the processor, an active multi-variate time series into the updated decoder head; and
predicting, by the processor, a future state variable value for the active multi-variate time series, based at least in part on the updated decoder head.

5. The computer-implemented method of claim 4, further wherein predicting the future state variable value comprises:
encoding, by the processor, the active multi-variate time series;
expanding, by the processor, active multi-variate time series encodings from an initial size to n number of phases;
decoding, by the processor, the expanded active multi-variate time series encodings, based on a decoder head;
compressing, by the processor, the decoded active multi-variate time series encodings; and
generating, by the processor, the state variable value from the decoded active multi-variate time series encodings based on a linear prediction head.

6. The computer-implemented method of claim 4, wherein the active multivariate time-series is associated with natural gas production system pressures.

7. The computer-implemented method of claim 4, wherein the active multivariate time-series is associated with chemical impurity output levels.

8. A computer system for training a multi-level mixer masked autoencoder with channel mixing across group dimensions model, the computer system comprising:
a processor;
a memory in communication with the processor;
one or more computer program instructions stored on the memory, when executed by the processor, cause the processor to perform one or more operations, the operations comprising:
receive a plurality of input features;
expand an input encoding from a time-series independent encoder;
correlation encode the expanded encodings, based at least in part on mixing the encodings through a least one of the following, channel mixing, spatial mixing, and channel mixing;
compress the correlation encodings;
decode the correlation encodings, based on a decoder head;
determine the error of the decoded correlation encodings compared to the plurality of input features; and
and update one or more weights of the decoder head based on the error.

9. The computer system of claim 8, wherein the decoder head is comprised of a thin decoder with mixer architecture and a linear prediction head.

10. The computer system of claim 8, wherein encoding the expanded input features further comprises:
expanding the time-series independent encoding, the, based at least in part on mixing the masked encodings through at least one of the following: intra patch mixing and interpatch mixing.

11. The computer system of claim 8, further comprising:
input an active multi-variate time series into the updated decoder head;
predict a future state variable value for the active multi-variate time series, based at least in part on the updated decoder head.

12. The computer system of claim 11, further wherein predicting the future state variable value comprises:
encode the active multi-variate time series;
expand the active multi-variate time series encodings from an initial size to n number of phases;
decode the expanded active multi-variate time series encodings, based on a decoder head;
compress the decoded active multi-variate time series encodings; and
generate the state variable value from the decoded active multi-variate time series encodings based on a linear prediction head.

13. The computer system of claim 11, wherein the active multivariate time-series is associated with natural gas production system pressures.

14. The computer system of claim 11, wherein the active multivariate time-series is associated with chemical impurity output levels.

15. A computer program product for training a multi-level mixer masked autoencoder with channel mixing across group dimensions model, the computer program product comprising:
program instructions stored on a memory device, executable by a processor to perform one or more operations, where in the program instructions comprise instructions to:
receive a plurality of input features;
expand an input encoding from a time-series independent encoder;
correlation encode the expanded encodings, based at least in part on mixing the encodings through a least one of the following, channel mixing, spatial mixing, and channel mixing;
compress the correlation encodings;
decode the correlation encodings, based on a decoder head;
determine the error of the decoded correlation encodings compared to the plurality of input features; and
and update one or more weights of the decoder head based on the error.

16. The computer program product of claim 15, wherein the decoder head is comprised of a thin decoder with mixer architecture and a linear prediction head.

17. The computer program product of claim 15, wherein encoding the expanded input features further comprises:
expanding the time-series independent encoding, the, based at least in part on mixing the masked encodings through at least one of the following: intra patch mixing and interpatch mixing.

18. The computer program product of claim 15, further comprising:
input an active multi-variate time series into the updated decoder head;
predict a future state variable value for the active multi-variate time series, based at least in part on the updated decoder head.

19. The computer program product of claim 18, further wherein predicting the future state variable value comprises:
encode the active multi-variate time series;
expand the active multi-variate time series encodings from an initial size to n number of phases;
decode the expanded active multi-variate time series encodings, based on a decoder head;
compress the decoded active multi-variate time series encodings; and
generate the state variable value from the decoded active multi-variate time series encodings based on a linear prediction head.

20. The computer program product of claim 18, wherein the active multivariate time-series is associated with natural gas production system pressures.
